(19) United States
(12) Patent Application Publication
(10) Pub. No.: US 2026/0220837 A1
(43) Pub. Date: Jul. 30, 2026

(54) GRAPHICAL DIAGRAMS BASED ON NATURAL LANGUAGE PROMPTS

(71) Applicant: Lucid Software, Inc., South Jordan, UT (US)

(72) Inventors: Benjamin N. Dilts, South Jordan, UT (US); Birch Eve, South Jordan, UT (US); Jae Kim, South Jordan, UT (US); Jason Henline, South Jordan, UT (US)

(21) Appl. No.: 19/038,378

(22) Filed: Jan. 27, 2025

(51) Int. Cl. G06T 11/20; G06F 40/40; G06T 11/60

(52) U.S. Cl. CPC G06T 11/26; G06T 11/60; G06F 40/40; G06T 2200/24

(57) ABSTRACT

In an example, a computer-implemented method to display graphical diagrams includes receiving, from a user, a natural language prompt defining a graphical diagram. The method includes generating, using an artificial intelligence (AI) model, the graphical diagram including multiple graphical objects based on the natural language prompt. The method includes displaying, on a display device, the graphical diagram including the multiple graphical objects. The method includes receiving from the user via the display device, manual input effective to modify the graphical diagram. The method includes modifying the graphical diagram according to the manual input using the AI model.

### FIELD

The embodiments discussed herein are related to graphical diagrams based on natural language prompts.

### BACKGROUND

Unless otherwise indicated herein, the materials described herein are not prior art to the claims in the present application and are not admitted as prior art by inclusion in this section.

Diagrams or other visualizations may help simplify representation of information. Some diagram applications allow users to generate graphical diagrams based on natural language or textual prompts. Such graphical diagrams may include graphical objects that represent and/or are associated with the natural language prompts.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a computer-implemented method to display graphical diagrams includes receiving, from a user, a natural language prompt defining a graphical diagram. The method includes generating, using an artificial intelligence (AI) model, the graphical diagram including multiple graphical objects based on the natural language prompt. The method includes displaying, on a display device, the graphical diagram including the multiple graphical objects. The method includes receiving from the user via the display device, manual input effective to modify the graphical diagram. The method includes modifying the graphical diagram according to the manual input using the AI model.

In another example embodiment, a non-transitory computer-readable medium has computer-readable instructions stored thereon that are executable by a processor to perform or control performance of operations. The operations include receiving, from a user, a natural language prompt defining a graphical diagram. The operations include generating, using an artificial intelligence (AI) model, the graphical diagram including multiple graphical objects based on the natural language prompt. The operations include displaying, on a display device, the graphical diagram including the multiple graphical objects. The operations include receiving from the user via the display device, manual input effective to modify the graphical diagram. The operations include modifying the graphical diagram according to the manual input using the AI model.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment that includes a server and one or more client devices;

FIGS. 2A-2D include graphical representations of a user interface (UI) to generate graphical diagrams;

FIGS. 3A-3D include other graphical representations of a UI to generate graphical diagrams;

FIG. 4 illustrates a flowchart of an example method to display graphical diagrams that may be implemented in the operating environment of FIG. 1 and/or the UIs of FIGS. 2A-2D; and

FIG. 5 is a block diagram illustrating an example computing device that is arranged to generate and/or display graphical diagrams,

all arranged in accordance with at least one embodiment described herein.

### DETAILED DESCRIPTION OF SOME EXAMPLE EMBODIMENTS

Some users may desire to generate graphical diagrams based on textual data. For example, the textual data may include steps of a process. As an example, the textual data may include steps, key concepts, themes, and/or relationships between parts of the textual data. Graphical diagrams generated based on the textual data may require specific formats and/or instructions. For example, the users may be required to provide the textual data and/or information extracted from the data, data structuring (e.g., lists, hierarchies, etc. that organize the extracted information into categories or sequences), specific diagram types, visual design, etc. to generate the data. Such process may be too technical, formal, and/or time-consuming for some types of users.

Another approach to generating diagrams based on textual data may include use of artificial intelligence (AI) models. For example, natural language prompts may be provided to an AI model. For example, instead of providing data with specific structures and/or relationships, users provide natural language prompts. The natural language prompts may include requests and/or instructions given in everyday or ordinary human language that conveys what users desire to inquire or achieve. The natural language prompts use conversational phrases instead of technical or formal commands, which may help accessibility and understandability. Such natural language prompts may be provided to AI models to generate a textual output representative of graphical diagrams based on the natural language prompts. The textual output may be used to generate the graphical diagrams. While such process of generating diagrams using AI models may provide improvements compared to approaches without the AI models, such diagrams may have challenges with respect to revisions and/or modifications. For example, each time an AI model is requested to make a revision and/or addition to a diagram, the AI model may regenerate the entire diagram including the revision and/or the addition. Alternatively or additionally, such AI models may be unable to revise or otherwise operate on or with diagrams in which users have made manual changes. For instance, some existing methods may not permit users to manually interact with the graphical diagrams generated using textual inputs or user prompts. For instance, the user may be required to make the revisions only through the user prompts.

Some embodiments herein may permit users to generate graphical diagrams based on natural language prompts, or more particularly graphical diagrams that are editable based on manual revisions from a user and/or additional natural language prompts. For example, a system may display, via a user interface (UI), a text input box, in which a user may provide prompts in natural language format. The prompts may generally define a graphical diagram to be generated. For example, the prompts may include instructions defining the graphical diagram. For example, the prompts may define different graphical objects included in the graphical diagram. The user may provide such definitions without specific format, permitting the user to provide the definitions with an increased level of freedom. The system may use an AI model to generate and revise or update the graphical diagram based on the prompts. For example, the AI model may generate textual outputs corresponding to one or more graphical objects and contents associated with the one or more graphical objects. A diagram application and/or a processor may generate the graphical diagram based on the textual outputs of the AI model.

In some embodiments, the graphical diagram may be displayed on the display device. The displayed graphical diagram may be revised and/or modified by the user via the graphical interface. In some instances, the user may directly revise the graphical diagram manually. For example, the user may manually modify one or more graphical objects, such as moving, adding, removing, and/or modifying the graphical objects. Additionally or alternatively, the user may provide additional prompts for the AI model of the system. In these and other embodiments, the AI model may consider the manual changes and the additional prompts to generate a revised graphical diagram. In some embodiments, the AI model may determine a subset of graphical objects that are affected by the prompts. The AI model may generate the revised graphical diagram by only modifying the subset of graphical objects without regenerating the entire graphical

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

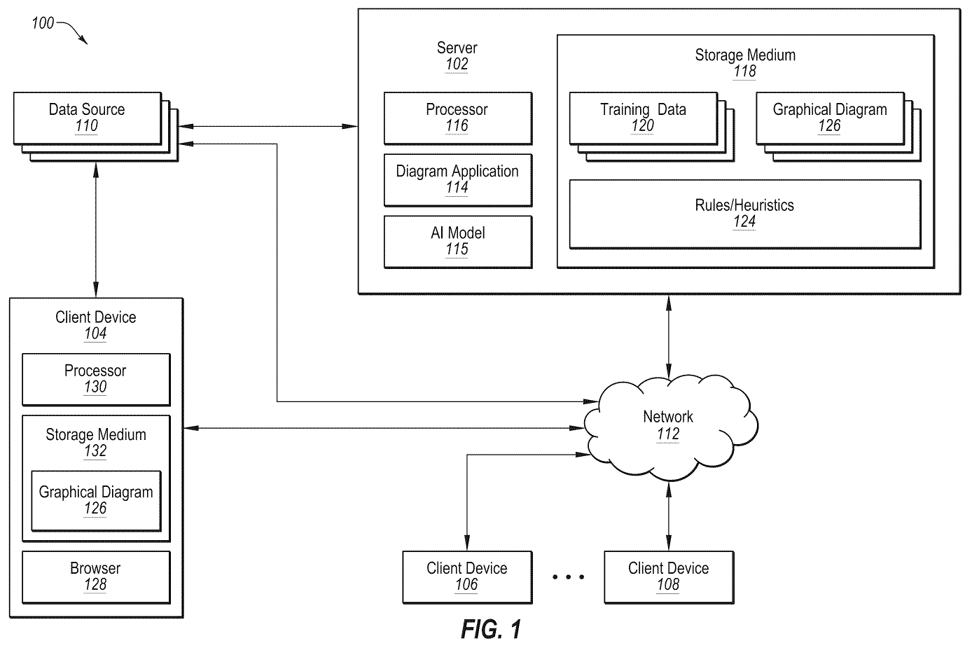

FIG. 1 is a block diagram of an example operating environment 100 that includes a server 102 and one or more client devices 104, 106, 108, arranged in accordance with at least one embodiment described herein. The server 102 and/or the client devices 104, 106, 108 may be configured to generate and display graphical diagrams or visualizations that include graphical objects based on user prompts. The terms graphical diagram and visualization are used interchangeably herein. In some embodiments, users may be able to revise graphical objects in graphical diagrams either directly or through additional user prompts.

The user prompts may be received from users via the one or more client devices 104, 106, 108. The operating environment 100 may include a network 112. In general, the network 112 may include one or more wide area networks (WANs) and/or local area networks (LANs) that enable the server 102, the client devices 104, 106, 108, and the data sources 110 to communicate with each other. In some embodiments, the network 112 may include the Internet, including a global internetwork formed by logical and physical connections between multiple WANs and/or LANs. Alternately or additionally, the network 112 may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network 112 may also include servers that enable one type of network to interface with another type of network.

In general, the server 102 may host a web-based diagram application (hereinafter application) 114 that allows the client devices 104, 106, 108 to generate and display graphical diagrams. In other embodiments, the application 114 may include a non-web-based application but may generally be described herein as a web-based application for simplicity. Alternatively or additionally, some or all of the functionality described as being performed by the diagram application 114 may be performed locally on the client devices 104, 106, 108, such as by a browser or other application executed by the client devices 104, 106, 108. In some embodiments, the application 114 may be configured to obtain user prompts at the client devices 104, 106, 108. For example, the application 114 may provide a text box at the client devices 104, 106, 108, in which the user using the client devices 104, 106, 108 may provide the user prompts.

In some embodiments, the user prompts may define the graphical diagram to be generated. For example, the user prompts may define the type of graphical diagram to be generated along with specific requirements. The types of graphical diagrams may include flowcharts, mind maps, organizational charts, Venn diagrams, network diagrams, Unified Modeling Language (UML) diagrams, wireframes, Gantt charts, swimlane diagrams, Entity-Relationship (ER) diagrams, site maps, infographics, etc., or other types of graphical diagrams. The user prompts may define a type of graphical diagram to be generated along with contents to be included. For example, a user may desire to generate a flowchart representing a method. In such instances, a user prompt may request a flowchart to be generated for a method, along with steps to be included in the method. As an example, a user may desire to generate a flowchart for a method of automating a customer support process from initial inquiry to resolution. The user prompt may include specific steps to be included in the flowchart, such as decision points for common scenarios, such as escalating issues, providing standard responses, and routing to specialized teams. In some embodiments, the user prompt may be presented in a natural language form. For example, the user prompt may recite “Draw me a flowchart for automating the customer support process, detailing each step from initial inquiry to resolution.”

The server 102 may additionally include a processor 116 and a storage medium 118. The processor 116 may be of any type such as a central processing unit (CPU), a microprocessor (μP), a microcontroller (μC), a digital signal processor (DSP), or any combination thereof. The processor 116 may be configured to execute computer instructions that, when executed, cause the processor 116 to perform or control performance of one or more of the operations described herein with respect to the server 102.

The storage medium 118 may include any non-transitory computer-readable medium, including volatile memory such as random access memory (RAM), persistent or non-volatile storage such as read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. The storage medium 118 may store computer instructions that may be executed by the processor 116 to perform or control performance of one or more of the operations described herein with respect to the server 102.

The server 102 may additionally include an AI model 115. The AI model 115 may be configured to generate the graphical diagram based on the user prompts. The AI model 115 may be trained using various types of prompts and corresponding graphical diagrams, such that the AI model 115 may generate response or textual outputs representative of graphical diagram based on various user prompts. The textual outputs may convert the natural language prompts into textual outputs more suitable for computing systems and/or applications for generating visualizations.

For example, the textual outputs of the AI model 115 may specify layouts, sizes, shapes, dimensions, styles, and/or any other specifications that may define one or more graphical objects to be included in the graphical diagrams. Additionally, the textual outputs may include the contents to be associated with the one or more graphical objects. For example, in response to the user prompt asking for a flowchart of customer support process, the AI model 115 may determine the steps of the customer support process, define one or more graphical objects to be associated with the steps and define how to graphically illustrate the steps using the one or more graphical objects. In these and other embodiments, the processor 116 and/or the diagram application 114 may be configured to generate the graphical diagrams based on such textual outputs. In the present disclosure, a reference to an AI model generating a graphical diagram may include reference to the AI model generating textual outputs that may be used by a computing system (e.g., the diagram application 114 and/or the processor 116) to generate the graphical diagram.

In some embodiments, the AI model 115 may include any suitable types of AI models that may generate outputs that may be used to generate graphical diagrams from natural language prompts. For example, the AI model 115 may include a large language model (LLM). The LLM may be configured to receive inputs or prompts in human-like natural language format and to generate an output corresponding to the input. The LLM may take the user prompts from the client devices 104, 106, 108 via the network 112. The LLM may generate textual outputs corresponding to graphical diagrams. The processor 116 and/or the diagram application 114 may generate the graphical diagrams, and the graphical diagrams may be communicated back to the client devices 104, 106, 108 via the network 112.

In some embodiments, the natural language prompts may be provided to the AI model 115 (e.g., by a user) at a high level of generality, with detailed specificity, or anywhere in between. For instance, in response to the foregoing high-level prompt to draw “a flowchart for automating the customer support process”, the AI model 115 may determine a general support process based on a database accessible to the AI model 115, determine one or more graphical objects corresponding to the general support process, and represent such graphical objects in a textual format. In response to a more detailed follow-on prompt to, e.g., add a step, path, or branch not included in the previously generated (or revised) flowchart, such as an alternative path for when customers request refunds or express dissatisfaction, the AI model 115 may revise and/or provide additional textual output for revising the flowchart to add the step, path or branch that was not included in the flowchart previously. It is not necessary in many cases for the user to specify in precise detail the exact steps, paths, branches, or other content to include in a graphical diagram as the AI model 115 may already have such content that it can include in the graphical diagrams it generates in response to more general and/or high-level prompts.

In some embodiments, the AI model 115 or the LLM (which may be included in or as the AI model 115) may be trained using a specific format of textual outputs. For example, the AI model 115 may be trained to generate the textual outputs in a certain format, such that the textual outputs may be used to generate graphical diagrams. A particular format may include ways to define the graphical objects in a suitable format for different systems such as the diagram application 114, such that the graphical diagrams may be generated in a more efficient and accurate manner.

In some embodiments, the storage medium 118 may include training data 120 and rules and/or heuristics 124 that may be used to train the AI model 115. The training data 120 may include various prompts (e.g., natural language prompts to generate graphical diagrams) represented in the specific format and example graphical diagrams corresponding to the prompts. The training data 120 may be used to train the AI model 115 to generate the textual outputs in the specific format in response to receiving prompts. Additionally, in some embodiments, the rules and/or heuristics 124 may include rules and/or heuristics that may be applied to the textual outputs and/or natural language prompts to generate corresponding graphical objects. For example, the rules and/or heuristics 124 may include different rules and styles to apply to the graphical objects based on the textual outputs.

Additionally or alternatively, the rules and/or heuristics 124 may include style guides and/or formatting to apply to the textual outputs. For example, in some instances, the textual outputs generated by the AI model 115 may require revisions to be more suitable for diagram generation. In these and other embodiments, the processor 116 and/or the diagram application 114 may parse and fix the textual outputs to be more diagram appropriate. For example, a particular rule of the rules and/or heuristics 124 may include making a certain graphical object a decision node (e.g., a diamond or a rhombus) if two distinct lines or transitions exit from the certain graphical object. In some embodiments, the AI model 115 or another AI model may be used to parse and/or improve the textual outputs.

Although one server 102 and three client devices 104, 106, 108 are illustrated in FIG. 1, the operating environment 100 may more generally include one or more servers 102 and one or more client devices 104, 106, 108. In these and other embodiments, the operating environment 100 may include other servers and/or devices not illustrated in FIG. 1.

Each of the client devices 104, 106, 108 may execute an application, such as the browser 128, configured to communicate through the network 112 with the server 102. The browser 128 may include an Internet browser or other suitable application for communicating through the network 112 with the server 102. Each of the client devices 104, 106, 108 may include a desktop computer, a laptop computer, a tablet computer, a mobile phone, a smartphone, a personal digital assistant (PDA), a wearable device (e.g., a smart watch), or another suitable client device.

Each of the client devices 104, 106, 108 may additionally include a processor and a storage medium, such as a processor 130 and a storage medium 132 as illustrated for the client device 104 in FIG. 1. Each of the other client devices 106, 108 may be similarly configured. Similar to the processor 116 of the server 102, the processor 130 may be of any type such as a CPU, a μP, a μC, a DSP, or any combination thereof. The processor 130 may be configured to execute computer instructions that, when executed, cause the processor 130 to perform or control performance of one or more of the operations described herein with respect to the client device 104 and/or the browser 128.

Similar to the storage medium 118 of the server 102, the storage medium 132 of the client device 104 may include any non-transitory computer-readable medium, including volatile memory such as RAM, persistent or non-volatile storage such as ROM, EEPROM, CD-ROM or other optical disk storage, magnetic disk storage or other magnetic storage device, NAND flash memory or other solid state storage device, or other persistent or non-volatile computer storage medium. The storage medium 132 may store computer instructions that may be executed by the processor 130 to perform one or more of the operations described herein with respect to the client device 104 and/or the browser 128. The storage medium 132 may additionally store, at least temporarily, a graphical diagram 126 and/or other content obtained from the server 102 and/or generated locally on the client device 104.

In some embodiments, the browser 128 on the client devices 104, 106, 108, the diagram application 114 on the server 102, and/or other application, system, or device may execute a layout algorithm to generate and display graphical diagrams 126 on displays of or coupled to the client devices 104, 106, 108. In some embodiments, the layout algorithm may generate the user interface (UI) on the displays. The UI may include a panel and a graphical drawing canvas. The panel may include a first portion configured to display the user prompts provided by the user and a text box in which the user may provide the user prompts. The graphical drawing canvas may be configured to display the graphical diagrams 126 generated based on the user prompts. In some embodiments, the UI may permit the user to directly interact with and/or revise the graphical diagrams 126 displayed in the graphical drawing canvas. For example, the user may select a part or all parts of the graphical diagrams 126 to modify. The user may perform one or more operations with respect to the selected parts of the graphical diagrams 126. For example, the user may move, modify relationships, edit contents, merge, separate, or take any other suitable operations with respect to the graphical objects. In these and other embodiments, the user may make such changes and/or revisions without considering the specific format used by the AI model 115 in generating the textual outputs.

Additionally or alternatively, the user may provide additional user prompts, via the text box, to cause the AI model 115 to modify the graphical diagrams 126. For example, the AI model 115 may generate additional textual outputs and/or modify prior textual outputs. In these and other embodiments, the AI model 115 may reiterate or update the textual outputs (and respectively the graphical diagrams 126) based on both the modifications made by the user and the additional user prompts. For example, the user may remove a graphical object or a step from a flowchart, then provide an additional user prompt adding additional steps to the flowchart. The AI model 115 may add the additional steps and keep the removed step removed.

In some embodiments, the user may manually generate the graphical diagram 126 within the graphical drawing canvas. For example, the user may use the drawings and/or drafting tools provided on the UI via the digital application 114 to generate the graphical diagram 126. In these and other embodiments, the user may provide a natural language prompt to modify and/or revise the manually generated graphical diagram 126. For example, the natural language prompt may cause the AI model 115 to analyze the manually generated graphical diagram 126 and to improve and/or clean up the graphical diagram 126. For example, the manually generated graphical diagram 126 may be a rough draft or initial version of the graphical diagram. The AI model 115 may generate a revised draft of the graphical diagram 126 based on the manually generated rough draft. Such processes of using the AI model 115 to generate and/or revise the graphical diagrams 126 may provide improvements over existing methods of generating diagrams based on textual inputs. For instance, some existing methods may not permit users to manually interact with the graphical diagrams generated using textual inputs or user prompts. For instance, the user may be required to make the revisions only through the user prompts. Additionally, the existing methods may not permit users to make partial revisions. For example, each time the user provides additional user prompts, the entire graphical diagram may be regenerated. The embodiments described herein permits users to make partial revisions manually and/or through additional user prompts provided to the AI model 115.

Embodiments described herein are not limited to using a browser to communicate with the server 102 to generate and display graphical diagrams 126 based on textual inputs. For example, rather than or in addition to a browser, the client devices 104, 106, 108 may include a native app as are often used on client devices such as mobile devices including smartphones and tablet computers. Accordingly, embodiments described herein generally include generating and displaying graphical diagrams using a browser, a native app, or another suitable application on the client devices 104, 106, 108.

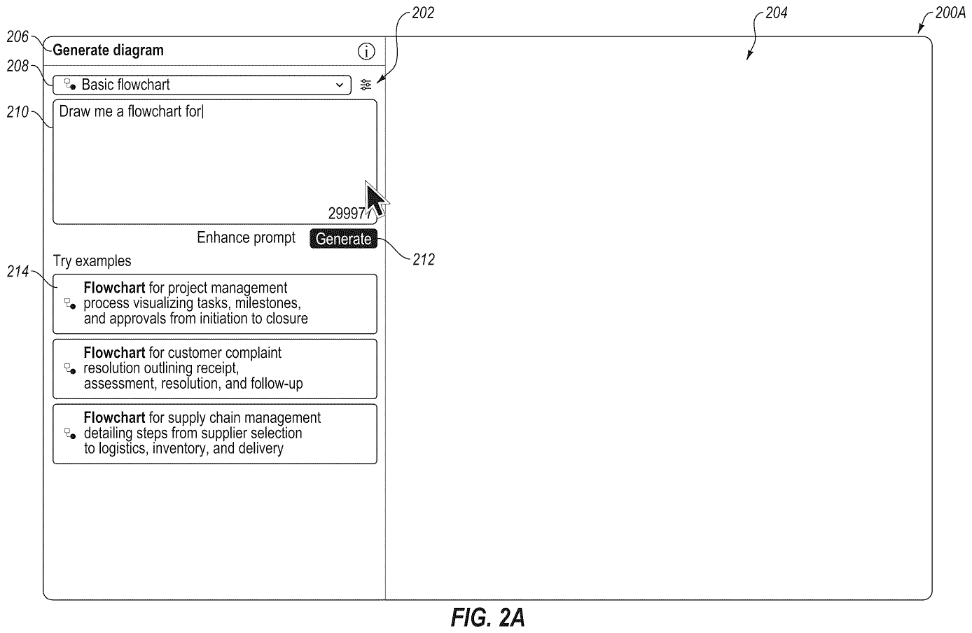

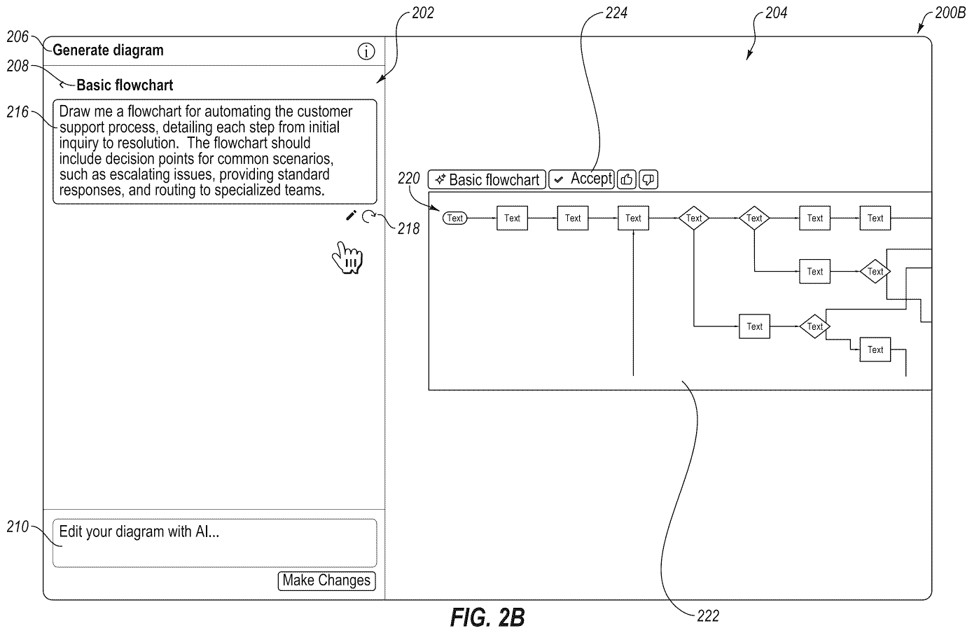

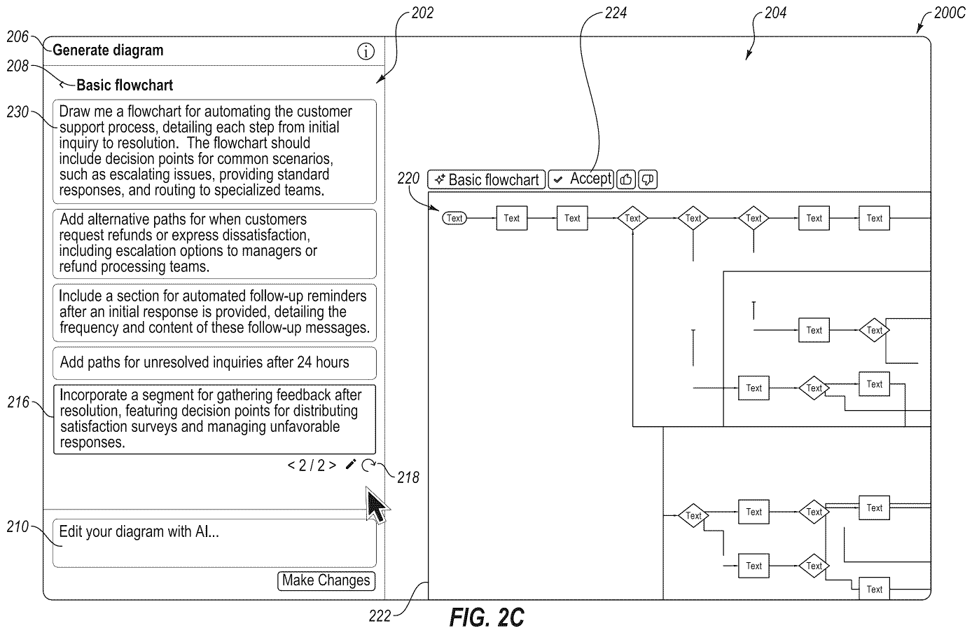

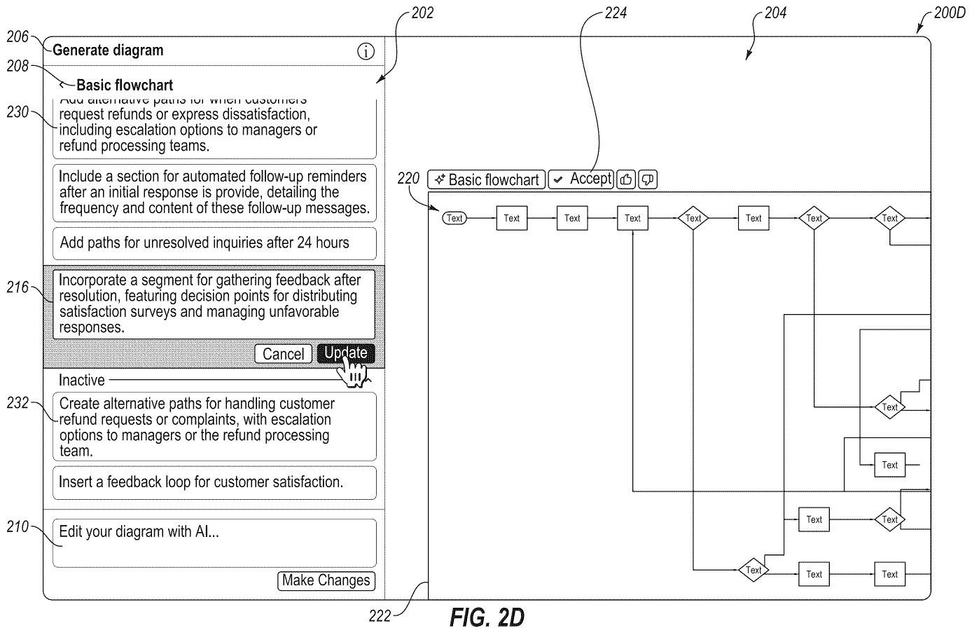

FIGS. 2A-2D include graphical representations 200A, 200B, 200C, 200D, 200E (collectively “graphical representations 200”) of a UI to generate graphical diagrams, arranged in accordance with at least one embodiment described herein. The UI may be provided by the browser 128 and/or the diagram application 114 of FIG. 1. For instance, the browser 128 in cooperation with the diagram application 114 may present the UI to a user through display of the client device 104.

In FIGS. 2A-2D, the graphical representations 200 include a panel 202 and a graphical drawing canvas 204 to one side of the panel 202. In other embodiments, the panel 202 may be positioned in another location relative to the graphical drawing canvas 204 and/or may be expanded into two or more panels. For example, the panel 202 may be positioned on a right side, above, or below the graphical drawing canvas 204 or other location relative to the panel 202 and/or may be divided into two or more panels positioned in two or more locations relative to the graphical drawing canvas 204.

In general, graphical diagrams may be displayed in the graphical drawing canvas 204. For example, in FIGS. 2B-2D, the graphical drawing canvas 204 displays an example graphical diagram 220 that includes various graphical objects. In some embodiments, graphical drawing canvas 204 may display the graphical diagram 220 within a diagram box 222 enclosing the graphical diagram 220. In some embodiments, the diagram box 222 may allow selection of the entire graphical diagram 220, e.g., by selection of the diagram box 222. In practice, one or more of the graphical objects within the graphical diagram 220 in FIGS. 2B-2D may include textual content (e.g., as parts of the flowchart generated by the AI model according to this example). However, the textual content may not be discernable at the zoom level of FIGS. 2B-2C.

In some embodiments, the panel 202 may may include a title 206 representing or describing the panel 202. In some embodiments, the panel 202 may include a diagram type field 208. Selecting the diagram type field 208 may display a list of types of graphical diagrams that may be generated. For example, selecting the diagram type field 208 may display a list (e.g., a drop-down list) of possible graphical diagrams to generate such as flowcharts, mind maps, organizational charts, Venn diagrams, network diagrams, Unified Modeling Language (UML) diagrams, wireframes, Gantt charts, swimlane diagrams, Entity-Relationship (ER) diagrams, site maps, infographics, etc.

In some embodiments, the panel 202 may include a text input box 210. The text input box 210 may be an input field, in which a user may provide user prompts. The user prompts may include instructions, commands, inquiries, and/or other prompts that the user may provide with respect to graphical diagrams 220. In some embodiments, the user prompts received via the text input box 210 may be communicated, via an API, to an AI model (e.g., an LLM), such as the AI model 115 of FIG. 1.

In some embodiments, the panel 202 may provide one or more examples 214 that may be selected. For example, in some embodiments, the one or more examples 214 may include descriptions of graphical diagrams that may be generated. Selection of one of the examples 214 may cause generation of the graphical diagram corresponding to the selected example on the graphical drawing canvas 204. In some embodiments, the examples 214 may include example natural language prompts that may be provided to the AI model (e.g., the AI model 115) to generate textual outputs corresponding to graphical diagrams. Additionally or alternatively, the examples 214 may include the natural language prompts and corresponding graphical diagrams included in the training data 120 of FIG. 1.

In some embodiments, the examples 214 may represent the user prompts being entered. For example, the examples 214 may represent the examples 214 in an improved or modified format that is more suitable for the AI model. For example, a particular user prompt may read “Generate a visualization for customer service.” A particular example 214 may read “Generate a flowchart for a process of customer service including customer complaint resolution, outlining receipt, assessment, resolution, and follow-up.” In these and other embodiments, the user may select or reject the recommended example 214.

Additionally or alternatively, in some embodiments, the user prompts received from the user may be automatically modified such that the prompts are more suitable for the AI model. For example, the formatting and/or wording of the prompts may be modified such that the AI model may interpret the prompts more accurately.

In some embodiments, in response to a user providing a user command or natural language prompt through the text input box 210, the user prompt may be listed within the panel 202. In some embodiments, in response to receiving a user prompt, the text input box 210 may be moved to one side of the panel 202 (or more generally a different location of the panel 202 than depicted in FIG. 2A) such that the user prompt may be displayed in the panel 202 at the currently displayed location of the text input box 210. In FIG. 2A, no user prompt has been received, such that only the text input box 210 is displayed in the panel 202. In FIG. 2B, a user prompt has been received and is displayed in the panel 202, in which the text input box 210 has moved to a different location (e.g., toward the bottom) of the panel 202. In other embodiments, the text input box 210 may be located at different locations within the panel 202 with respect to displayed user prompt. For example, the text input box 210 may be placed above, left of, or right of the displayed user prompt. In some embodiments, the most recent user prompt obtained and listed in the panel 202 may be referred to as a current user prompt 216.

In response to receiving the current user prompt 216, a corresponding graphical diagram 220 may be generated within the graphical drawing canvas 204. For example, the AI model may generate a response or textual output corresponding to the current user prompt 216. The response may define the graphical diagram 200 in a textual format, including details and/or contents of one or more graphical objects of the graphical diagram 200. For example, the current user prompt 216 may merely request generation of a flowchart for a certain method or process. The textual output may specify the elements of the flowchart (e.g., the one or more graphical objects and contents) for the certain process, such that the graphical diagram 200 may be generated. The textual output may be provided to an application, a processor, or a module configured for diagram generation. The graphical diagram 220 may be communicated to the client device such that the graphical diagram 220 may be displayed at the client device. In some embodiments, the graphical diagram 220 may be placed inside a diagram box 222 displayed within the graphical drawing canvas 204. The diagram box 222 and the graphical diagram 220 may be placed and/or be displayed such that the diagram box 222 encloses the graphical diagram 220.

In some embodiments, the diagram box 222 may include an accept button 224. Selection of the accept button 224 (e.g., by the user) may approve of the graphical diagram 220 displayed within the diagram box 222. In these and other embodiments, an approved graphical diagram 220 may be finalized for presentation. In some embodiments, a finalized graphical diagram 220 may not be further revised. In other embodiments, a finalized graphical diagram 220 may be further modified. In instances in which the user does not desire to accept the graphical diagram 220, the user may discard or revise the graphical diagram. For instance, the user may select a regenerate button 218 associated with the current user prompt 216, such that the AI model may regenerate the graphical diagram 220 (via regenerated textual outputs) based on the same current user input 216. In these and other embodiments, a new graphical diagram generated using the AI model may be different even in which the current user prompt 216 remains the same.

In some embodiments, the user may sequentially enter a series of prompts to sequentially modify the graphical diagram 220. For example, FIGS. 2C and 2D each depict multiple prompts within the panel 202. The prompts may be depicted in an order in which they were entered. In the example of FIG. 2C, for instance, an oldest prompt is at the top of the panel 202 with subsequently entered prompts provided thereafter in their order of entry.

In some embodiments, the user may revise a previously entered prompt, in which case a previously entered prompt may become the current user prompt 216 while the user is revising the previously entered prompt. For example, FIG. 2D illustrates the current user prompt 216 being a previously entered user prompt that is in the process of being revised or updated. FIG. 2D corresponds to a point in time after FIG. 2C in which FIG. 2D includes all of the same prompts as in FIG. 2C with some additional prompts. In addition, the last prompt in FIG. 2C is not the last prompt in FIG. 2D but has become the current user prompt 216 insofar as the user is currently revising that prompt in FIG. 2D. In response to the current user prompt being updated, the updated current user prompt 216 may be communicated to the AI model such that the AI model may revise or update the graphical diagram 220 in accordance therewith.

In some embodiments, the user may directly or manually modify and/or revise the graphical diagram 220 via the graphical drawing canvas 204 instead of or in addition to modifying or revising the graphical diagram 220 via the text input box 210. For example, the user may select one or more graphical objects of the graphical diagram 220 displayed on the graphical drawing canvas 204. The user may perform one or more operations with respect to the selected graphical objects. For example, the one or more operations may include moving, editing shapes, editing texts, removing objects, adding additional objects, rerouting connections, etc. In some embodiments, in response to selecting certain graphical objects, a list of available operations for the certain graphical objects may be provided to the user. For example, a pop-up menu or a dropdown menu may be displayed (e.g., over the canvas 204 or in some other location) that includes the list of available operations.

Additionally or alternatively, in some embodiments, the graphical diagram 220 may be revised or iterated using additional user prompts. For example, the user may provide additional user prompts via the text input box 210. In some embodiments, the additional user prompts may build on top of the graphical diagram 220 generated based on the previous user prompt. In these and other embodiments, the additional user prompts may be added to the panel 202 such that a record of user prompts applied to the graphical diagram 220 may be maintained. In these and other embodiments, the most recent additional user prompt may become the current user prompt 216. Any user prompt that that has already been applied to and remains applied to the graphical diagram 220 may be labeled or referred to as an active prompt. For example, FIG. 2C illustrates active prompts 230. In some embodiments, the active prompts 230 may be listed in a sequence of received time. For example, the active prompts 230 may be listed in an order of received time from top to bottom. In other embodiments, the active prompts 230 may be listed in a sequence from bottom to top, left to right, right to left, etc.

In some embodiments, in response to obtaining an additional user prompt, the AI model may revise the graphical diagram 220. For instance, the additional user prompt may be communicated to the AI model such that the AI model may cause revisions to the graphical diagram 220. In some embodiments, one or more manual changes may be made to the graphical diagram 220 prior to the additional user prompt but after the previous user prompt. For example, the user may make manual changes to the graphical diagram 220 and then provide the additional user prompt to make further revisions. In these and other embodiments, the AI model may consider both the manual changes and the additional user prompt in making the revisions to the graphical diagram 220. For example, the AI model may generate additional or revised textual outputs based on both the manual changes and the additional user prompt. In some embodiments, the AI model may identify one or more graphical objects that are affected by the manual changes and/or the additional user prompt. For instance, only a subset of graphical objects of the graphical diagram 220 may be affected by the manual changes and/or the additional user prompt. In these and other embodiments, the AI model may only revise the one or more graphical objects affected by the manual changes and/or the additional user prompt without regenerating the entire graphical diagram 220.

In some embodiments, certain user prompts received from the user may not be applied to the graphical diagram 220. For instance, the user may decide to replace a particular user prompt and/or decide that the particular user prompt is not useful. In such instances, the user may select to remove the particular user prompt from the graphical diagram 220. In these and other embodiments, the particular user prompt may remain displayed on the panel 202 but labeled as an inactive prompt. For example, FIG. 2D illustrates inactive prompts 232. In some embodiments, the inactive prompts 232 may be differentiated from the active prompts 230. For example, the inactive prompts 232 may be of a different color from the active prompts 230, may be greyed out, may be obscured/hidden, may be toggled off, or may otherwise be identified as not being active. Additionally or alternatively, the inactive prompts 232 may be labelled as inactive, as illustrated in FIG. 2D.

In some embodiments, multiple graphical diagrams may be generated. For example, an additional prompt may request a new graphical diagram to be generated in addition to the graphical diagram 220. In some embodiments, a new graphical diagram may be generated within the same diagram box 222 as the graphical diagram 220. In other embodiments, a second diagram box may be displayed in the graphical drawing canvas 204, in which the new graphical diagram is generated.

In some embodiments, the user may desire to combine and/or associate parts of the graphical diagram 220 and at least a part of the new graphical diagram. For instance, the user may desire to combine and/or associate at least one graphical object of the graphical diagram 220 to at least one graphical object of the new graphical diagram. In these and other embodiments, the user may select one or more graphical objects from the graphical diagram 220 and one or more graphical objects from the new graphical diagram. In some embodiments, the user may manually combine and/or associate the selected graphical objects across the graphical diagrams. Additionally or alternatively, the user may provide an additional user prompt specifying the combinations and/or the associations to be made between the graphical objects across the graphical diagram 220 and the new graphical diagram.

In some embodiments, the UI may permit users to rate, approve, accept, or otherwise provide feedback with respect to the graphical diagram 220. For instance, the UI may provide one or more buttons configured for receiving feedback on (e.g., a rating of) the graphical diagram 220. As an example, the UI may include a thumbs-up button and a thumbs-down button, in which the thumbs-up button represents positive feedback, and the thumbs-down button represents negative feedback. In other embodiments, the UI may include a more detailed mechanism such as a text field to enter scores, a sliding scale, or other mechanism. Such feedback may be used to improve the AI model 115. In some embodiments, the rating and/or other feedback may be available after each iteration or modification of the graphical diagram 220. For example, the user may rate each iteration of the graphical diagram 220 following each modification. In other embodiments, a feedback or rating may be available after the graphical diagram 220 is finalized.

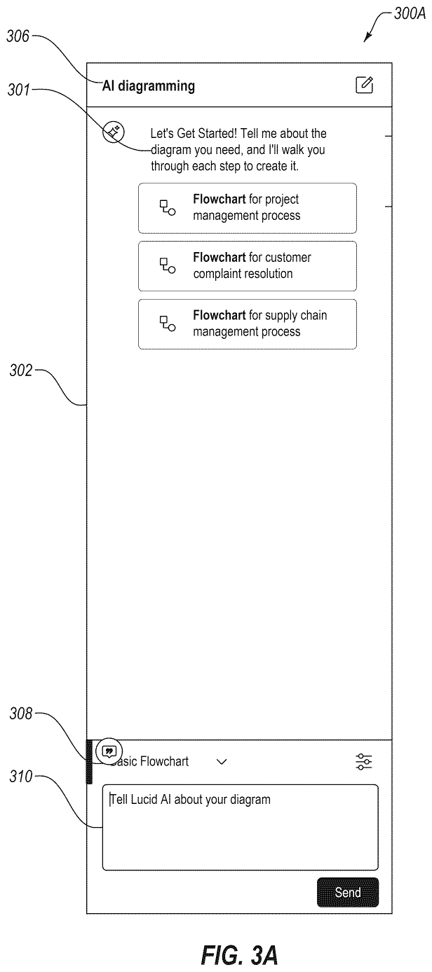

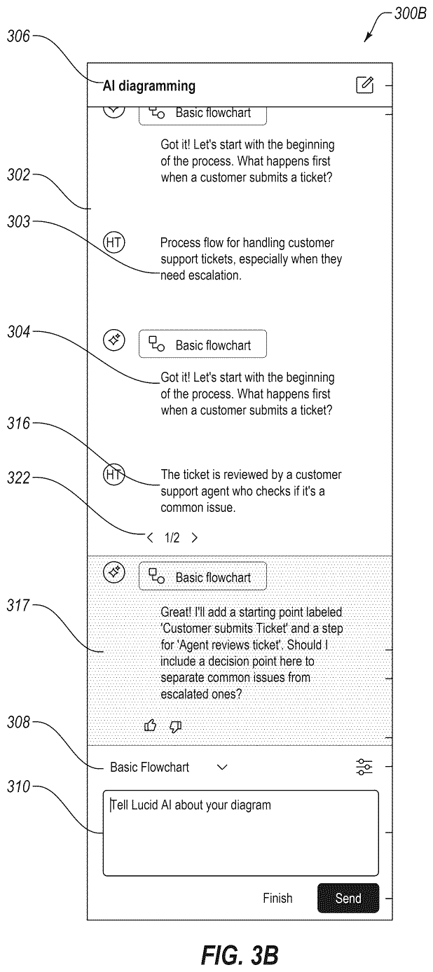

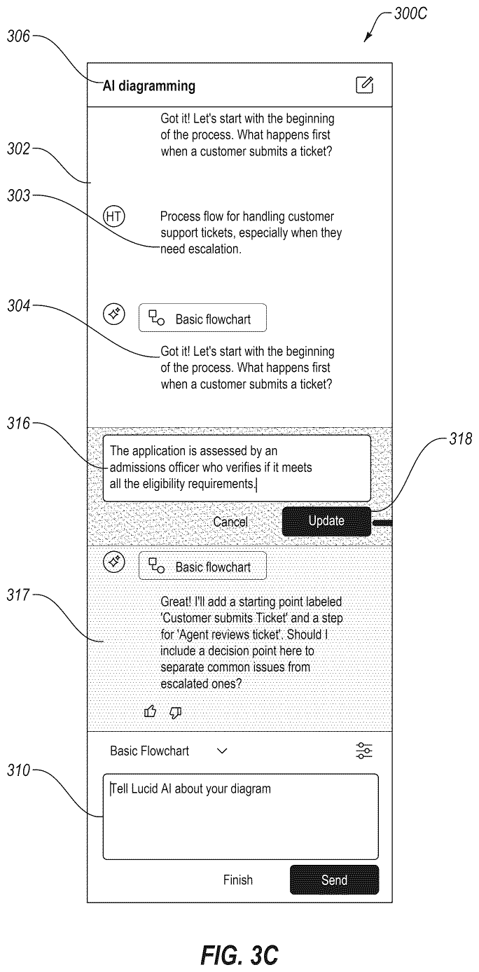

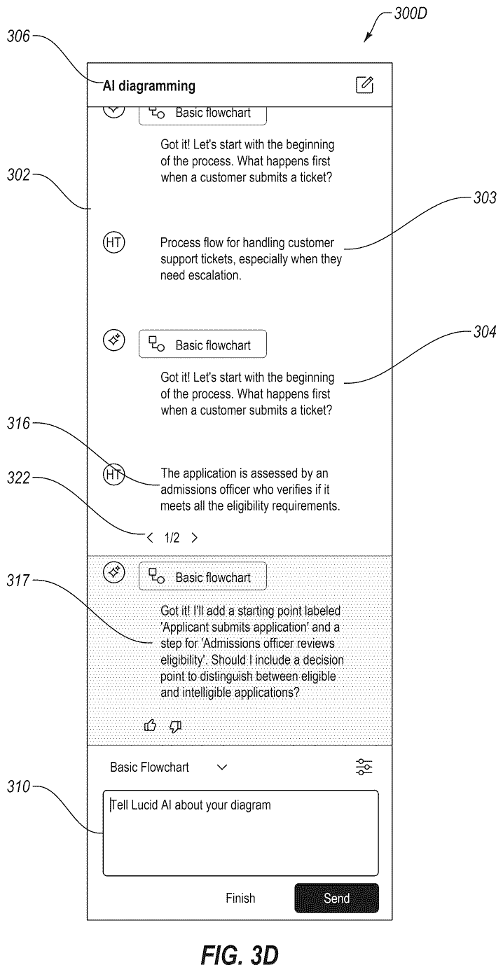

FIGS. 3A-3D include graphical representations 300A, 300B, 300C, 300D (collectively “graphical representations 300”) of a UI to generate graphical diagrams, arranged in accordance with at least one embodiment described herein. The UI may be provided by the browser 128 and/or the diagram application 114 of FIG. 1. For instance, the browser 128 in cooperation with the diagram application 114 may present the UI to a user through display of the client device 104. In some embodiments, the graphical representations 300 may be a version of the graphical representations 200 of FIGS. 2A-2E.

Although the graphical representations 300 only illustrate a panel 302, the graphical representations 300 may include other parts such as a drawing canvas, such as the graphical drawing canvas 204 of FIGS. 2A-2E. In some embodiments, the panel 302 may correspond to the panel 202 of FIGS. 2A-2E. For example, the panel 302 may be a version of the panel 202.

In some embodiments, the panel 302 may include a title 306 representing or describing the panel 302. In some embodiments, the panel 302 may include a diagram type field 308. Selecting the diagram type field 308 may display a list of types of graphical diagrams that may be generated. For example, selecting the diagram type field 308 may display a list (e.g., a drop-down list) of possible graphical diagrams to generate such as flowcharts, mind maps, organizational charts, Venn diagrams, network diagrams, Unified Modeling Language (UML) diagrams, wireframes, Gantt charts, swimlane diagrams, Entity-Relationship (ER) diagrams, site maps, infographics, etc.

In some embodiments, the panel 302 may include a text input box 310. The text input box 310 may be an input field, in which a user may provide user prompts. The user prompts may include instructions, commands, inquiries, and/or other prompts that the user may provide with respect to graphical diagrams. In some embodiments, the user prompts received via the text input box 310 may be communicated, via an API, to an AI model (e.g., an LLM), such as the AI model 115 of FIG. 1. The text input box 310 may permit the user to communicate with the AI model in a conversational manner.

In some embodiments, the panel 302 may include an initialization 301 or a phrase initiating conversation or interaction with the user. For example, the initialization 301 may prompt the user to provide user prompts. In these and other embodiments, the user may provide a user prompt via the text input box 310. For example, in FIG. 3B, the panel 302 illustrates a first user prompt 303 provided by the user. The first user prompt 303 may include user prompts related to graphical diagrams to be generated.

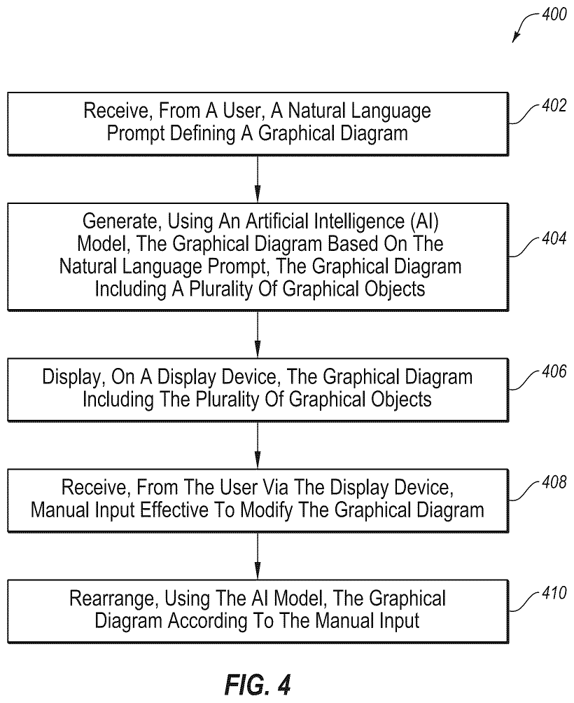

In some embodiments, in response to the first user prompt 303, the AI model may generate a first AI response 304. In some embodiments, the first AI response 304 may include an acknowledgement of receipt of the first user prompt 303 by the AI model. In some embodiments, along with the first AI response 304, a graphical diagram may be generated based on the first user prompt 303. Alternatively or additionally, the first AI response 304 may include a question from the AI model to the user. For example, the first AI response 304 may ask the user to provide additional information regarding the graphical diagram with respect to the first user prompt 303. In some embodiments, the generation of the graphical diagram based on the first user prompt 303 may be implemented as described elsewhere herein, such as with respect to FIG. 1 and/or FIG. 4 of the present disclosure.

In some embodiments, AI responses such as the first AI response 304 may be presented using natural or conversational language. For example, the AI responses may be generated in the way humans communicate (e.g., use of grammar, syntax, vocabulary, semantics, etc.). Such natural language may help improve usability of the system. For instance, users may communicate with the AI model and cause graphical diagrams to be generated without knowledge of technical formats or languages. In some embodiments, the tone and/or the style of the AI responses may be predetermined. Additionally or alternatively, the tone and/or the style of the AI responses may match or correspond to the tone and/or the style of the user prompts.

In some embodiments, the user may provide, via the text input box 310, a second user prompt 316. The second user prompt 316 may include a response to the first AI response 304. For example, the second user prompt 316 may provide the requested information or clarify parts of the first user prompt 303. Additionally or alternatively, the second user prompt 316 may include additional instructions for the AI model. For example, the second user prompt 316 may include instructions to revise and/or modify the graphical diagram generated based on the first user prompt 303.

In response to the second user prompt 316, the AI model may generate, on the panel 302, a second AI response 317. The second AI response 317 may include an acknowledgement, and/or additional questions for the user. Additionally or alternatively, the second AI response 317 may include a summary of how the AI model interprets the second AI response 317. In these and other embodiments, the graphical diagram generated based on the first user prompt 303 may be modified based on the second user prompt 316.

In some embodiments, user prompts may be revised following an AI response. For example, FIG. 3C illustrates the second user prompt 316 being modified. The modification may include partial or complete modification. For example, the user may modify a part of the second user prompt 316 or completely rewrite the second user prompt 316. In these and other embodiments, the panel 302 may include an update button 318, which the user may select to update the second user prompt 316. Such modification of the user prompts may permit the user to modify the prompts to guide the AI model in a more preferred direction in generating the graphical diagrams.

In these and other embodiments, different versions of the second user prompt 316 may be stored. For example, a first version of the second user prompt 316 and a second version of the second user prompt 316 (including modifications from the first version) may be stored. In these and other embodiments, a version indicator may represent a number of versions and a current version of a particular user prompt (e.g., the second user prompt 316). For example, FIG. 3D illustrates a version indicator 322 indicating that a current version is the second version of the second user prompt 316 out of two available versions. The version indicator may be toggled between versions by the user, e.g., to change the graphical diagram.

In these and other embodiments, in response to the second user prompt 316 being modified, corresponding second AI response 317 and the graphical diagram may be modified according to the second user prompt 316. For example, the second AI response 317 in FIG. 3D illustrates changes made compared to the second AI response 317 illustrated in FIG. 3C.

In some embodiments, the user may cause the same user prompt to be retried. For example, the user may not obtain a desired output (e.g., the graphical diagrams) from a particular user prompt. In some embodiments, the user may cause the AI model to process the same user prompt without making modifications. In some instances, the graphical diagram generated based on the same user prompt may vary.

FIG. 4 illustrates a flowchart of an example method 400 to generate graphical diagrams, arranged in accordance with at least one embodiment described herein. The method 400 may be performed by any suitable system, apparatus, or device. For example, any one or more of the client devices 104, 106, 108, the application 114, and/or the server 102 of FIG. 1 may perform or direct performance of one or more of the operations associated with the method 400. In these and other embodiments, the method 400 may be performed or controlled by one or more processors based on one or more computer-readable instructions stored on one or more non-transitory computer-readable media. Alternatively or additionally, embodiments herein may include a non-transitory computer-readable medium having computer-readable instructions stored thereon that are executable by a processor to perform or control performance of the method 400 or one or more operations thereof. The method 400 may include one or more of blocks 402, 404, 406, 408 and/or 410.

At block 402, the method 400 may include receiving, from a user, a natural language prompt defining a graphical diagram. For example, block 402 may include obtaining the natural language prompt via the text input box 210 of FIGS. 2A-2D. The natural language prompt may include human-like everyday language. Block 402 may be followed by block 404.

At block 404, the method 400 may include generating, using an artificial intelligence (AI) model, the graphical diagram based on the natural language prompt. A reference to the AI generating the AI graphical diagram may refer to the AI model generating textual outputs corresponding to and/or representing the graphical diagram and generating the graphical diagram based on the textual outputs. For example, the AI model may generate a response corresponding to the natural language prompt. The response may textually define and layout one or more graphical objects to be included in the graphical diagram. Different systems such as a diagram application may be used to generate the graphical diagram based on the response generated using the AI model. In some embodiments, the graphical diagram may include multiple graphical objects. The AI model, such as the AI model 115 of FIG. 1, may be configured to obtain the natural language prompt and cause generation of the graphical diagram by the processor and/or the diagram application. In some embodiments, the textual outputs may be generated in a specific format and/or style suitable for the processor and/or the diagram application to generate the graphical diagram. In some embodiments, the AI model may be or include a large language model. Block 404 may be followed by block 406.

At block 406, the method 400 may include, displaying, on a display device, the graphical diagram including the multiple graphical objects. For example, block 406 may include displaying the graphical diagram on the display device associated with client devices such as the client devices 104, 106, 108 of FIG. 1. In some embodiments, the graphical diagram may be displayed within a particular UI such as illustrated with respect to FIGS. 2A-2D. For example, the graphical diagram may correspond to the graphical diagram 220 of FIGS. 2A-2D. Block 406 may be followed by block 408.

At block 408, the method 400 may include receiving from the user via the display device, manual input effective to modify the graphical diagram. In some embodiments, the manual input may include direct modification of the graphical diagram via the display, or the UI displayed on the display. Additionally or alternatively, an additional natural language prompt may be received from the user. In these and other embodiments, both the manual input and the additional natural language prompt may be provided to the AI model, such that the AI model considers both the natural language prompt and the additional natural language prompt in making revisions and/or updates. Block 408 may be followed by block 410.

At block 410, the method 400 may include modifying, using the AI model, the graphical diagram according to the manual input. For example, the AI model may modify, create, delete, and/or rearrange one or more graphical objects of the graphical diagram (by generating additional or revised textual outputs) to reflect the manual input and/or any additional natural language prompt.

In some embodiments, the input received at block 408 may include a first input selecting at least one graphical object of the multiple graphical objects. For example, the user may specifically select one or more graphical objects of the multiple graphical objects via the UI displayed on the display. In some embodiments, the input received at block 408 may further include a second input editing the at least one graphical object. For example, the second input may include an action with respect to the at least one graphical object, such as moving, rerouting, revising, and/or removing the at least one graphical object, among others. Additionally or alternatively, the input received at block 408 may include user-generated contents to be added to the graphical diagram. For example, the user-generated contents may include contents or text to be added to the at least one graphical object. As another example, the user generated contents may include additional graphical objects to be added to the graphical diagram.

In some embodiments, modifying the graphical diagram at block 410 includes identifying modifications manually made on the graphical diagram by the user. For example, the edits, revisions, and/or additions made at block 408 may be identified. Based on the identified modifications, one or more graphical objects of the multiple graphical objects that are affected by the modifications may be determined. In some embodiments, modification made to a particular graphical object may affect other graphical objects that are not directly modified. For example, an addition of a new graphical object may require rerouting between the graphical objects, in which the graphical objects that are being rerouted to the new graphical objects are affected. As another example, a change to a step in a method process may require changes to other steps in the method process. In these and other embodiments, the one or more graphical objects of the multiple objects may be updated based on the identified modifications. In some embodiments, the AI model may be configured to consider the graphical diagram and the modifications in updating the one or more graphical objects of the multiple graphical objects based on the modifications. For example, the AI model or the system associated with the AI model may analyze the manual modifications made directly with the graphical diagram, as well as the additional prompts, rather than ignoring the manual modifications as done by some traditional approaches.

In some embodiments, the method 400 may further include generating a second graphical diagram. For example, in some embodiments, multiple graphical diagrams, including the second graphical diagram, may be generated. For example, an additional prompt may request the second graphical diagram to be generated in addition to the graphical diagram. In these and other embodiments, a second graphical diagram may be displayed along with the graphical diagram.

In some embodiments, the method 400 may further include receiving a user input selecting a first subset of the graphical diagram and a second subset of the second graphical diagram. The first subset and the second subset may each include one or more graphical objects from the respective graphical diagrams. In some embodiments, the method 400 may further include receiving a second user input indicating a link between the first subset and the second subset. For example, the link may indicate a grouping of the first subset and the second subset. For example, the link my indicate routing between the first subset and the second subset. In these and other embodiments, the method 400 may further include grouping the first subset and the second subset together based on the second user input. In some embodiments, grouping may include making any suitable types of associations between the first subset and the second subset. For example, grouping may include routing, grouping, connecting, replacing, etc.

In some embodiments, the method 400 may include displaying, on the display device, a UI including a panel and a text input box. For example, the panel may correspond to the panel 202 of FIGS. 2A-2D and the text input box may correspond to the text input box 210 of FIGS. 2A-2D. In these and other embodiments, the natural language prompt received at block 402 may be received from the user via the text input box.

The method 400 may further include communicating the natural language prompt to an application programming interface (API). The API may be used to communicate the natural language prompt to the AI model configured to generate the graphical diagram based on the natural language prompt. In some embodiments, the method 400 may further include displaying the natural language prompt on the panel.

In some embodiments, the method 400 may further include receiving a second natural language prompt from the user. For example, the second natural language prompt may be received via the text input box. In some embodiments, the second natural language prompt may build on top of the natural language prompt. For example, the second natural language prompt may include instructions and/or commands to be performed with respect to the graphical diagram generated based on the natural language prompt. In these and other embodiments, the second natural language prompt may be displayed on the panel. For example, the second natural language prompt may be displayed after, along, or next to the natural language prompt on the panel. The graphical diagram may be accordingly updated, using the AI model, based on the second natural language prompt.

In some embodiments, the panel may be configured to display all or a portion of all natural language prompts obtained via the text input box. In some embodiments, the natural language prompts may include different types. For example, the natural language prompts may include active prompts, a current prompt, and/or inactive prompts. The active prompts may include prompts applied to the graphical diagram. The current prompt may include the most recent active prompt. The inactive prompts may include prompts that are not currently applied to the graphical diagram. For example, the inactive prompts may include prompts removed from the graphical diagram.

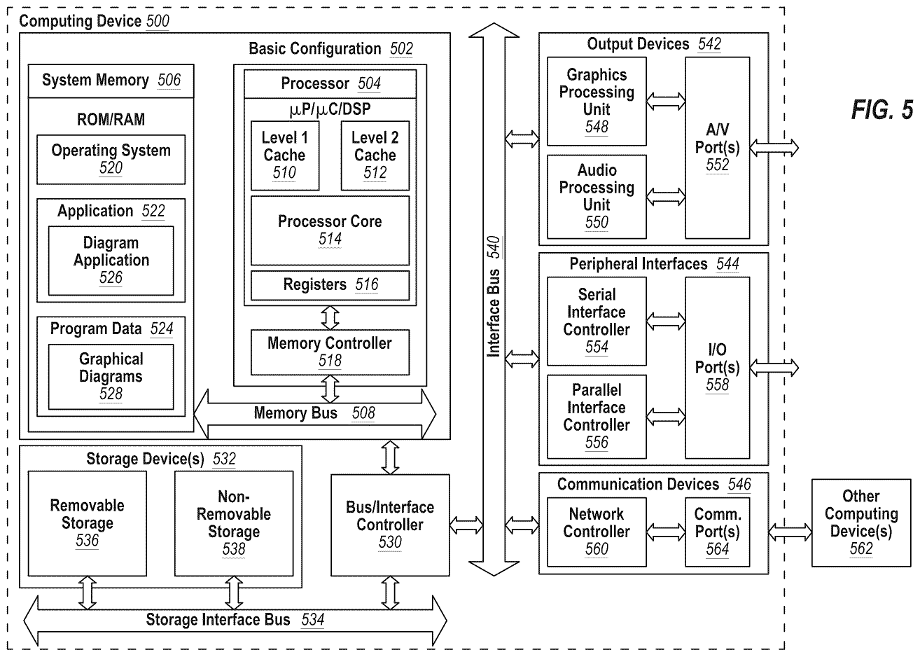

FIG. 5 is a block diagram illustrating an example computing device 500 that is arranged to generate and/or display graphical diagrams, arranged in accordance with at least one embodiment described herein. The computing device 500 may include, be included in, or otherwise correspond to either or both of the server 102 or the client devices 104, 106, 108 of FIG. 1. In a basic configuration 502, the computing device 500 typically includes one or more processors 504 and a system memory 506. A memory bus 508 may be used to communicate between the processor 504 and the system memory 506.

Depending on the desired configuration, the processor 504 may be of any type including, but not limited to, a microprocessor (μP), a microcontroller (μC), a digital signal processor (DSP), or any combination thereof. The processor 504 may include one or more levels of caching, such as a level one cache 510 and a level two cache 512, a processor core 514, and registers 516. The processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may include an internal part of the processor 504.

Depending on the desired configuration, the system memory 506 may be of any type including volatile memory (such as RAM), nonvolatile memory (such as ROM, flash memory, etc.), or any combination thereof. The system memory 506 may include an operating system 520, one or more applications 522, and program data 524. The application 522 may include a diagram application 526 that is arranged to generate and/or display graphical diagrams. The diagram application 526 may include, be included in, or otherwise correspond to the diagram application 114 of FIG. 1. The program data 524 may include graphical diagrams 528 (which may include, be included in, or otherwise correspond to the graphical diagrams 126 of FIG. 1) and/or other graphical data. In some embodiments, the application 522 may be arranged to operate with the program data 524 on the operating system 520 such that one or more methods may be provided as described herein.

The computing device 500 may have additional features or functionality, and additional interfaces to facilitate communications between the basic configuration 502 and any involved devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 506, the removable storage devices 536, and the non-removable storage devices 538 are examples of computer storage media or non-transitory computer-readable media. Computer storage media or non-transitory computer-readable media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other non-transitory medium which may be used to store the desired information, and which may be accessed by the computing device 500. Any such computer storage media or non-transitory computer-readable media may be part of the computing device 500.

The computing device 500 may also include an interface bus 540 to facilitate communication from various interface devices (e.g., output devices 542, peripheral interfaces 5544, and communication devices 546) to the basic configuration 502 via the bus/interface controller 530. The output devices 542 include a graphics processing unit 548 and an audio processing unit 550, which may be configured to communicate to various external devices such as a display or speakers via one or more A/V ports 552. Diagrams, flowcharts, organizational charts, connectors, and/or other graphical objects generated by the diagram application 526 may be output through the graphics processing unit 548 to such a display. The peripheral interfaces 5544 include a serial interface controller 554 or a parallel interface controller 556, which may be configured to communicate with external devices such as input devices (e.g., keyboard, mouse, pen, voice input device, touch input device, etc.), sensors, or other peripheral devices (e.g., printer, scanner, etc.) via one or more I/O ports 558. Such input devices may be operated by a user to provide input to the diagram application 526, which input may be effective to, e.g., generate curved connectors, designate points as designated points of one or more curved connectors, relocate one or more designated points, and/or to accomplish other operations within the diagram application 526. The communication devices 546 include a network controller 560, which may be arranged to facilitate communications with one or more other computing devices 562 over a network communication link via one or more communication ports 564.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 500 may be implemented as a portion of a small-form factor portable (or mobile) electronic device such as a smartphone, a personal data assistant (PDA) or an application-specific device. The computing device 500 may also be implemented as a personal computer including tablet computer, laptop computer, and/or non-laptop computer configurations, or a server computer including both rack-mounted server computer and blade server computer configurations.

Embodiments described herein may be implemented using computer-readable media for carrying or having computer-executable instructions or data structures stored thereon. Such computer-readable media may be any available media that may be accessed by a general-purpose or special-purpose computer. By way of example, such computer-readable media may include non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method to display graphical diagrams, the method comprising:
receiving, from a user, a natural language prompt defining a graphical diagram;
generating, using an artificial intelligence (AI) model, the graphical diagram based on the natural language prompt, the graphical diagram including a plurality of graphical objects;
displaying, on a display device, the graphical diagram including the plurality of graphical objects;
receiving, from the user via the display device, manual input effective to modify the graphical diagram; and
modifying, using the AI model, the graphical diagram according to the manual input.

2. The computer-implemented method of claim 1, wherein:
receiving, from the user via the display device, the manual input effective to modify the graphical diagram includes:
receiving input selecting at least one graphical object of the plurality of graphical objects; and
receiving input editing the at least one graphical object.

3. The computer-implemented method of claim 1, wherein:
receiving, from the user via the display device, the manual input effective to modify the graphical diagram includes receiving user generated contents to be added to the graphical diagram.

4. The computer-implemented method of claim 1, wherein:
modifying, using the AI model, the graphical diagram according to the manual input includes:
identifying modifications manually made on the graphical diagram by the user;
determining one or more graphical objects of the plurality of graphical objects affected by the modifications; and
updating the one or more graphical objects of the plurality of graphical objects based on the modifications.

5. The computer-implemented method of claim 4, wherein the AI model is configured to consider the graphical diagram and the modifications in updating the one or more graphical objects of the plurality of graphical objects based on the modifications.

6. The computer-implemented method of claim 1, wherein the AI model includes a large language model (LLM).

7. The computer-implemented method of claim 1, further comprising:
generating a second graphical diagram;
receiving a user input selecting a first subset of the graphical diagram and a second subset of the second graphical diagram;
receiving a second user input indicating a link between the first subset and the second subset; and
grouping the first subset and the second subset together.

8. The computer-implemented method of claim 1, wherein:
the method further comprises displaying, on the display device, a user interface (UI) including a panel and a text input box;
receiving, from the user, the natural language prompt defining the graphical diagram comprises receiving the natural language prompt from the user via the text input box;
the method further comprises communicating the natural language prompt to an application programming interface (API); and
the method further comprises displaying the natural language prompt on the panel.

9. The computer-implemented method of claim 8, further comprising:
receiving a second natural language prompt from the user, the second natural language prompt building on top of the natural language prompt;
displaying the second natural language prompt on the panel; and
updating, using the AI model, the graphical diagram based on the second natural language prompt.

10. The computer-implemented method of claim 8, wherein the panel is configured to display one or more of active prompts, a current prompt, or inactive prompts, wherein the active prompts include prompts applied to the graphical diagram, the current prompt includes a most recent current prompt, and the inactive prompts include prompts that are not currently applied to the graphical diagram.

11. A non-transitory computer-readable medium having computer-readable instructions stored thereon that are executable by a processor to perform or control performance of operations comprising:
receiving, from a user, a natural language prompt defining a graphical diagram;
generating, using an artificial intelligence (AI) model, the graphical diagram based on the natural language prompt, the graphical diagram including a plurality of graphical objects;
displaying, on a display device, the graphical diagram including the plurality of graphical objects;
receiving, from the user via the display device, manual input effective to modify the graphical diagram; and
modifying, using the AI model, the graphical diagram according to the manual input.

12. The non-transitory computer-readable medium of claim 11, wherein:
receiving, from the user via the display device, the manual input effective to modify the graphical diagram includes:
receiving input selecting at least one graphical object of the plurality of graphical objects; and
receiving input editing the at least one graphical object.

13. The non-transitory computer-readable medium of claim 11, wherein:
receiving, from the user via the display device, the manual input effective to modify the graphical diagram includes receiving user generated contents to be added to the graphical diagram.

14. The non-transitory computer-readable medium of claim 11, wherein:
modifying, using the AI model, the graphical diagram according to the manual input includes:
identifying modifications manually made on the graphical diagram by the user;
determining one or more graphical objects of the plurality of graphical objects affected by the modifications; and
updating the one or more graphical objects of the plurality of graphical objects based on the modifications.

15. The non-transitory computer-readable medium of claim 14, wherein the AI model is configured to consider the graphical diagram and the modifications in updating the one or more graphical objects of the plurality of graphical objects based on the modifications.

16. The non-transitory computer-readable medium of claim 11, wherein the AI model includes a large language model (LLM).

17. The non-transitory computer-readable medium of claim 11, the operations further comprising:
generating a second graphical diagram;
receiving a user input selecting a first subset of the graphical diagram and a second subset of the second graphical diagram;
receiving a second user input indicating a link between the first subset and the second subset; and
grouping the first subset and the second subset together.

18. The non-transitory computer-readable medium of claim 11, wherein:
the operations further comprise displaying, on the display device, a user interface (UI) including a panel and a text input box;
receiving, from the user, the natural language prompt defining the graphical diagram comprises receiving the natural language prompt from the user via the text input box;
the operations further comprise communicating the natural language prompt to an application programming interface (API); and
the operations further comprise displaying the natural language prompt on the panel.

19. The non-transitory computer-readable medium of claim 18, the operations further comprising:
receiving a second natural language prompt from the user, the second natural language prompt building on top of the natural language prompt;
displaying the second natural language prompt on the panel; and
updating, using the AI model, the graphical diagram based on the second natural language prompt.

20. The non-transitory computer-readable medium of claim 18, wherein the panel is configured to display one or more of active prompts, a current prompt, or inactive prompts, wherein the active prompts include prompts applied to the graphical diagram, the current prompt includes most recent current prompt, and the inactive prompts include prompts that are not currently applied to the graphical diagram.
